(19) United States
(12) Patent Application Publication
(10) Pub. No.: US 2010/0003390 A1
(43) Pub. Date: Jan. 7, 2010

(54) METHOD FOR ADDING FUNCTIONAL COMPONENTS TO HYDROCOLLOID BASES THAT REQUIRE COOKING

(75) Inventors: Martin Rifkin, Vancouver, WA (US); Mary Ann Galloway, ND, Newberg, OR (US); Michael F. Cleary, Vancouver, WA (US)

Correspondence Address: DORSEY & WHITNEY LLP;INTELLECTUAL PROPERTY DEPARTMENT, Columbia Center, 701 Fifth Avenue, Suite 6100, SEATTLE, WA, 98104-7043, US

(73) Assignee: Avid Health, Inc., Vancouver, WA (US)

(21) Appl. No.: 12/168,019

(22) Filed: Jul. 3, 2008

(51) Int. Cl. A23L 1/05

(52) U.S. Cl. 426/573

(57) ABSTRACT

Functional components are often cooked with hydrocolloid bases to create a more palatable and nutritional product. Mixing the functional components and hydrocolloid base together and cooking the mixture often results in damage to the functional components. The damage caused to the functional components result in a reduction in the potency of the functional components or may otherwise adversely affect the functional components. Conversely, adding the functional components to the hydrocolloid base after the base has been cooked and cooled minimizes the damage caused to the functional components.

### TECHNICAL FIELD

This invention is directed toward a method of adding functional components to hydrocolloid based foods that require cooking. In particular, this invention relates to preventing damage to the functional components after the functional components have been added to the hydrocolloid base.

### BACKGROUND OF THE INVENTION

In the dietary supplement industry, functional components may be added to a food product, such as a confectionary product, to mask the taste of the functional component or to improve other properties of the supplement. For example, functional components, such as vitamins, may be added to a confectionary base so that children will enjoy the taste and be more likely to eat the vitamin. Functional components added to food may include any variation of vitamins, minerals, herbs, botanical or other nutritional supplements, preservatives or other substances.

Many different types of bases may be used to improve the taste of a functional component. For example, hydrocolloid bases have been used to improve the taste for a variety of different types of functional components. Hydrocolloid bases typically form into a gel when mixed with water and heated.

The process of making hydrocolloid based foods typically includes a high temperature cooking step. In the past, the functional components have been added to the hydrocolloid base prior to the cooking step. FIG. 1 is a flow chart for a conventional method of adding functional components to hydrocolloid bases that require cooking. Colloids are mixed with water to form a hydrocolloid base during a first mixing step 20. In addition, one or more functional components 10 may be added to the hydrocolloid base during the first mixing step 20. The first mixing step 20 is a hot mixing step, where the mixing step 20 is typically performed at about 185° F. During the first mixing step 20, the functional component(s) 10 is thoroughly mixed with the hydrocolloid base. After completion of the first mixing step 20, the hydrocolloid base and the functional component(s) 10 are cooked at temperatures greater than the first mixing step 20 during a cooking step 22. The hydrocolloid base typically reaches temperatures around 240° F. during the cooking step 22. The duration of the cooking step 22 at the highest temperature may be less than one minute.

After completion of the cooking step 22 the base and the functional component mixture are cooled during a cooling step 24. The cooling step 24 reduces the temperature of the mixture to about equal to or less than the temperature at the first mixing step 20. Once the mixture has cooled, the mixture goes through a second mixing step 26. During the second mixing step 26 colors, flavors and acids may be added to mixture. The mixture is then put into molds in a molding step 28. The product then goes through a conditioning step 30 to solidify the gel. The solidified product then goes through a final finishing step 32.

Because the functional component 10 is added to the hydrocolloid base before the cooking step 22, the functional component 10 is exposed to the high temperatures of the cooking step 22. High temperature can affect the potency or efficacy of functional components, particularly if those components are heat sensitive materials. Both the temperature and duration of the cooking step 22 can reduce the potency of the functional components 10. More specifically, high temperatures and long cooking times cause damage to functional components and thus lead to the loss of some of the functional components' effectiveness. Furthermore, the proper dosage necessary to meet label claims becomes unclear since it is difficult to predict the amount of reduction in potency to the functional component 10.

One reason for the damage to the functional components during the cooking step is due to chemical reactions that can occur during high temperatures. Furthermore, the functional components are highly reactive at these elevated temperatures. In particular, the functional components oxidize from the oxygen in the mixture, thus changing the chemical make up of the components. Chemical changes to the functional components reduce the potency of the functional component.

Therefore, there is a need for a method of adding functional components to hydrocolloid bases that require cooking without reducing the potency of or otherwise adversely affecting the functional components.

### SUMMARY OF THE INVENTION

The present invention is directed toward a method for adding at least one functional component to a hydrocolloid base. In one aspect of the invention, the method includes heating a hydrocolloid base to a temperature greater than 185° F., cooling the hydrocolloid base, after cooling the hydrocolloid base, adding at least one functional component to the base.

In another aspect of the invention, a method for making a supplement includes cooking a hydrocolloid base, the cooking temperature being greater than 185° F., cooling the base, providing at least one functional component to the cooled base, mixing the functional component with the cooled base to create a mixture, and placing the mixture into a mold.

Another aspect of the invention includes a method for making an edible hydrocolloid based food. The method includes heating the hydrocolloid base to a temperature greater than 185° F., flash cooling the base, adding a functional component to the base after flash cooling the base, and placing the resultant mixture into a mold.

### BRIEF DESCRIPTION OF THE DRAWINGS

FIG. 1 is a flow diagram illustrating a method for adding a functional component to a hydrocolloid base in accordance with the prior art.

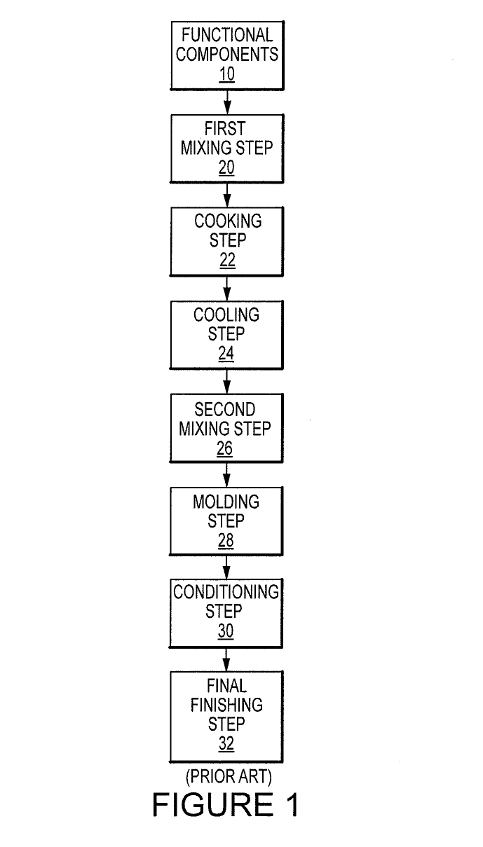

FIG. 2 is a flow diagram illustrating a method for adding a functional component to a hydrocolloid base in accordance with one embodiment of the invention.

### DETAILED DESCRIPTION

Embodiments of the present invention are directed toward a method for adding functional components to hydrocolloid bases that have previously been cooked. In particular, functional components are added to the hydrocolloid bases by a method that minimizes the amount of damage to the functional component. Certain details are set forth below to provide a sufficient understanding of the invention. However, it will be clear to one skilled in the art that the invention may be practiced without these particular details.

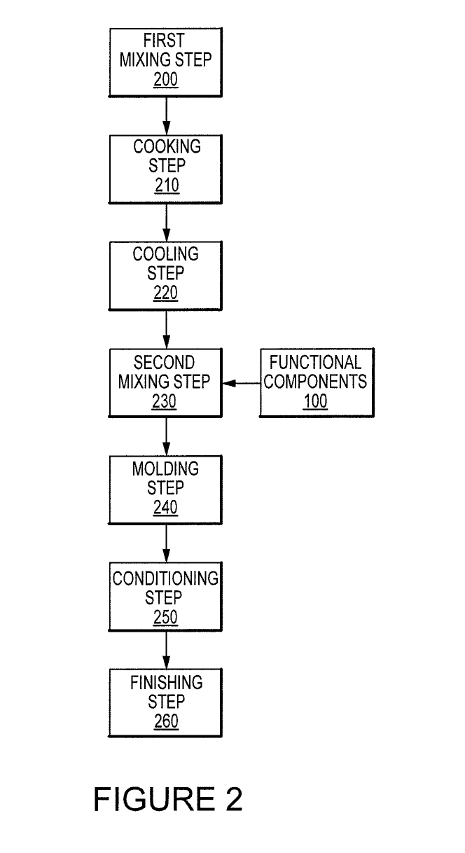

FIG. 2 is a block diagram illustrating a method of adding the functional component to a hydrocolloid base in accordance with one embodiment of the invention. The first step of the method is a first mixing step 200. In the first mixing step 200, powdered hydrocolloids are mixed with water to form a hydrocolloid base. Examples of hydrocolloid bases include gum, porcine, gelatin, cornstarch and apple pectin. However many other types of hydrocolloid bases may be used. The hydrocolloid base may also include a sweetener, which may contain: sucrose, corn syrup, invert sugar, glucose, fructose or other sugars. The base ingredients are thoroughly mixed in large baths. The batches may be large. For instance, in one embodiment, the batch comprises approximately 400 kilograms. The first mixing step 200 may be performed at temperatures above room temperature. In one embodiment the first mixing step 200 is performed at a temperature of about 185° F.

After the hydrocolloid base is mixed, the cooking step 210 begins. Prior to the cooking step 210, however, the base may be stored in a surge tank. The surge tank operates as a holding tank for storing the hydrocolloid base prior to the cooking step. The surge tank may continue to provide heat to the base. From the surge tank, the hydrocolloid base is transferred to the cooking step 210. If no surge tank is used, however, the base may be transferred directly to cooking step 210 from the first mixing step 200.

The cooking step 210 cooks the base at a temperature greater than the first mixing step 200. The high temperatures of the cooking step 210 heats the hydrocolloid base to promote gel formation. As one skilled in the art will know, different temperatures and times may be used depending on the type of hydrocolloid base being cooked. The cooking step may be performed by batch cooking. However, the base may be cooked in smaller volumes than the first mixing step 200 in order to control the consistency of the cooking process. In one embodiment, the base is cooked in batches of roughly 30 kilograms.

In another embodiment of the invention, however, the hydrocolloid base is cooked in a continuous cooking coil, such as a flow-through cooking coil where the mixture of the hydrocolloid base and sweeteners is passed through the coil surrounded by steam. The base goes through the high temperature cooking step 210 while in the cooking coil. The temperature of the hydrocolloid base within the coil may reach temperatures of 240° F. or greater. The duration of the cooking time may depend upon the temperature. For example, the duration of the cooking time in the cooking coil at temperatures of 240° F. may be less than 1 minute or some other time period.

After the base has completed the cooking step 210, the base begins the cooling step 220. The cooling step 220 lowers the temperature of the base to less than 185° F. The cooling step may cool the base quickly. In one embodiment, the cooling step 220 is performed at the exit of the flow through coils of the cooking step 210. Thus, the heating and cooling processes may be sequentially continuous. In another embodiment, the cooling step 220 is a vacuum flash cooling step, where the cooling step 220 cools the base in less than 20 seconds. As will be understood by persons skilled in the art, the flash cooling step may include a change in pressure. During the cooling step 220 water vapor may be removed from the base. In one embodiment, up to 7% of the mass of the base is removed due to vapor loss during the cooling step 220.

Following the cooling step 220, a second mixing step 230 may be performed. The second mixing step 230 may be performed in smaller batches than the first mixing step 200. In one embodiment, the second mixing step 230 comprises individual batches of about 30 kilograms. Coloring and/or flavoring are typically added to the base during the second mixing step 230. Typically, citric acid may be added to the base during the second mixing step 230. The citric acid, which may be substituted or combined with lactic, malic, asorbic acid or the like, promotes gel formation by lowering the pH of the base.

Functional components 100 are also added to the base during the second mixing step 230. Functional components 100 may include vitamins, minerals, herbals, and/or botanicals. However, other functional components 100 may be used. One or more functional components 100 may be added to the base. When multiple functional components 100 are added, the functional components 100 may be combined prior to adding them to the base. Premixing the functional components 100 separately from the base can assist in the even distribution of the functional components 100 throughout the base. Premixing multiple functional components 100 may involve one or more premixing steps. In one embodiment, the premixing step involves multiple premixing steps where the functional components 100 are mixed in a first premixing tank and filtered and mixed in a second premixing tank. In another embodiment, each functional component 100 is added to the base individually. As mentioned earlier, colors, flavors, and citric acid are also added to the base during the second mixing step 230.

The functional components 100 may be added to the base in liquid and/or powder form. In one embodiment, liquid functional components 100 are added to the base by mixing the premixed functional component into the cooled base. An example of multiple liquid functional components 100 being injected into the base includes a liquid mixture of Vitamin C, Vitamin E, and Omega-3 fatty acid esters.

Adding the functional components 100 to the base produces a base mixture. The base mixture is thoroughly mixed during the second mixing step 230 so that the functional components 100 are distributed throughout the base. The duration of the second mixing step 230 depends on the time required to thoroughly mix the functional components 100 into the base. In one embodiment, the second mixing step 230 lasts for approximately less than 1 minute.

Adding the functional components 100 to the base after the base has cooled prevents the damage to the functional components 100 that occurs during the high temperature cooking step 210. In particular, because the base is less reactive at lower temperatures and there is less oxygen in the mixture after cooking and flash cooling, the functional component 100 is less likely to oxidize. Therefore, the potency of the functional component 100 is better protected and the dosage more adequately controlled.

After the base mixture has been thoroughly mixed during the second mixing step 230, the base mixture is ready for the molding step 240. Any type of mold may be used. In one embodiment molding step 240 comprises starch molds. In the starch molding process, starch is placed in a tray and leveled. Positive molds are pressed into the starch to create depressions. The base mixture is placed into the depressions in the starch. The base mixture continues to cool as it is placed into the mold.

After the base mixture has been placed into molds, the conditioning step 250 begins. During the conditioning step 250, the base mixture continues to cool and begins the process of solidifying the gel. The environment during the conditioning step 250 may be controlled. In particular, the temperature and humidity of the environment may be controlled in order to control the amount of moisture that is removed from the base mixture and the rate at which the base mixture cools. Furthermore, when starch molds are used, the moisture content of the starch also influences the amount of moisture removed from the base mixture. Up to 4% of the mass of the base mixture may be removed due to moisture loss during the conditioning step 250 when starch molds are used. As will be understood by those skilled in the art, the duration of the conditioning step depends on the desired amount of moisture loss and the temperature and humidity of the environment. Typically, the conditioning step may last between 4 and 48 hours. In one embodiment, the conditioning step lasts 20 hours. Once the base mixture solidifies during the conditioning step 250, the base mixture forms into a gelled product.

After the conditioning step 250 is complete, the gelled product goes into the finishing step 260. During the finishing step 260 the product is removed from the molds. Upon removal from the molds, the product has completed the gelling process. Additionally, final processing of the product may be conducted during this finishing step 260, such as cleaning, coating and/or packaging the product.

Although the present invention has been described with reference to the disclosed embodiments, persons skilled in the art will recognize that changes may be made in form and detail without departing from the spirit and scope of the invention. Such modifications are well within the skill of those ordinarily skilled in the art. Accordingly, the invention is not limited except as by the appended claims.

We claim:

1. A method of adding at least one functional component to a hydrocolloid base, comprising:
heating the hydrocolloid base to a temperature greater than 185° F.;
cooling the hydrocolloid base; and
after cooling the hydrocolloid base, combining the at least one functional component with the hydrocolloid base.

2. The method of claim 1 wherein cooling the hydrocolloid base comprises cooling the base to a temperature less than 185° F.

3. The method of claim 1 wherein heating the hydrocolloid base comprises heating the base to a temperature greater than 200° F.

4. The method of claim 4 wherein the base is maintained at a temperature greater than 235° F. for less than 5 minutes.

5. The method of claim 1 further comprising placing the mixture into a mold.

6. The method of claim 5 wherein the mold is a starch mold.

7. A method for making a dietary supplement, comprising:
cooking a hydrocolloid base, the cooking temperature being greater than 185° F.;
cooling the hydrocolloid base;
providing at least one functional component to the cooled hydrocolloid base;
mixing the functional component with the cooled hydrocolloid base to create a mixture; and
placing the mixture into a mold.

8. The method of claim 7 wherein multiple functional components are provided to the cooled hydrocolloid base.

9. The method of claim 8 wherein the mold is a starch mold and the starch mold removes moisture from the mixture.

10. The method of claim 7 wherein the mixture gels while in the mold.

11. The method of claim 7 wherein providing the functional component to the base comprises mixing the functional component into the base.

12. The method of claim 7 further comprising cooling the mixture after being placed into the mold.

13. The method of claim 12 wherein the mixture gels while in the mold.

14. A method of making an edible hydrocolloid-based food comprising:
heating a hydrocolloid base to a temperature greater than 185° F.;
flash cooling the base;
adding a functional component to the base after flash cooling the base; and
placing the functional component and the base into a mold.

15. The method of claim 14 wherein flash cooling the base comprises flash cooling the base in at least a partial vacuum.

16. The method of claim 15 wherein the base is flash cooled in less than 2 minutes.

17. The method of claim 14 wherein the mold is a starch mold.

18. An edible product made from the steps comprising:
heating a hydrocolloid base to a temperature greater than 185° F.;
cooling the base;
after cooling the base, mixing at least one functional component into the base;
placing the mixture into a mold.

19. The edible product of claim 18 wherein the mold is a starch mold.

20. The edible product of claim 18 wherein cooling the base comprises flash cooling the base.

21. The edible product of claim 18 wherein the base is cooled to a temperature less than 185° F.
